(19) United States
(12) Patent Application Publication
(10) Pub. No.: US 2024/0238825 A1
(43) Pub. Date: Jul. 18, 2024

(54) ARTICULATED AND EXTENDIBLE ROTARY HEAD FOR A PRESSURISED AIR JET SPRAY GUN

(71) Applicant: DANIEL Casero CORTAVITARTE, Aviles Espana (ES)

(72) Inventor: DANIEL Casero CORTAVITARTE, Aviles Espana (ES)

(21) Appl. No.: 16/966,904

(22) PCT Filed: Feb. 1, 2019
(86) PCT No.: PCT/ES2019/000008

§ 371 Date: Jan. 8, 2021

(30) Foreign Application Priority Data
Feb. 2, 2018 (ES) P201800031

(51) Int. Cl. B05B 15/652; B05B 7/24; B05B 12/00

(52) U.S. Cl. CPC B05B 15/652; B05B 7/2478; B05B 12/002

(57) ABSTRACT

The invention relates to an articulated and extendible rotary head for a pressurised air jet spray gun, formed by rotary modules that are articulated, combined and stacked such that they can be bent for use on corners or edges. The first module is a supporting clamp module in the form of a quadrilateral with curved sides attached using swivel screws to the body of the gun or to another rear or front clamp module, through which extend a bellows that channels the liquid to be sprayed, two air supply hoses and the needle obstructing the paint opening, all terminating in a front-end second module in the form of a hollow truncated cylinder with a central outlet for spray liquid, blocked by a shut-off needle tip that can be extracted by pulling a trigger in order to release the spray jet, with the needle divided into two parts connected by a flexible, high-tenacity traction wire and a recovery spring.

### TECHNICAL FIELD

The proposed invention is appropriated for the industrial accessories for painting and preparing surfaces of every type of industrial devices, vehicles, furniture or buildings industry.

### BACKGROUND TO THE PREVIOUS TECHNICAL SITUATION

In the current state of the art in the industry of spray-painting, treatment or reparation of surfaces as automobiles bodyworks, boats, vehicles, industrial devices, furniture or buildings, the pressurised air jet spray gun is commonly used and it is formed by a handle or a tank for paint or another impregnation liquid connected to a pressurised air source to be applied to a body surface, a traction trigger that retracts from the head a shut-off needle tip of the impregnation liquid to allow jet beam outlet in which there are openings for pressurised air independent outlet supplied by hoses from a compressor or another pressurised air source.

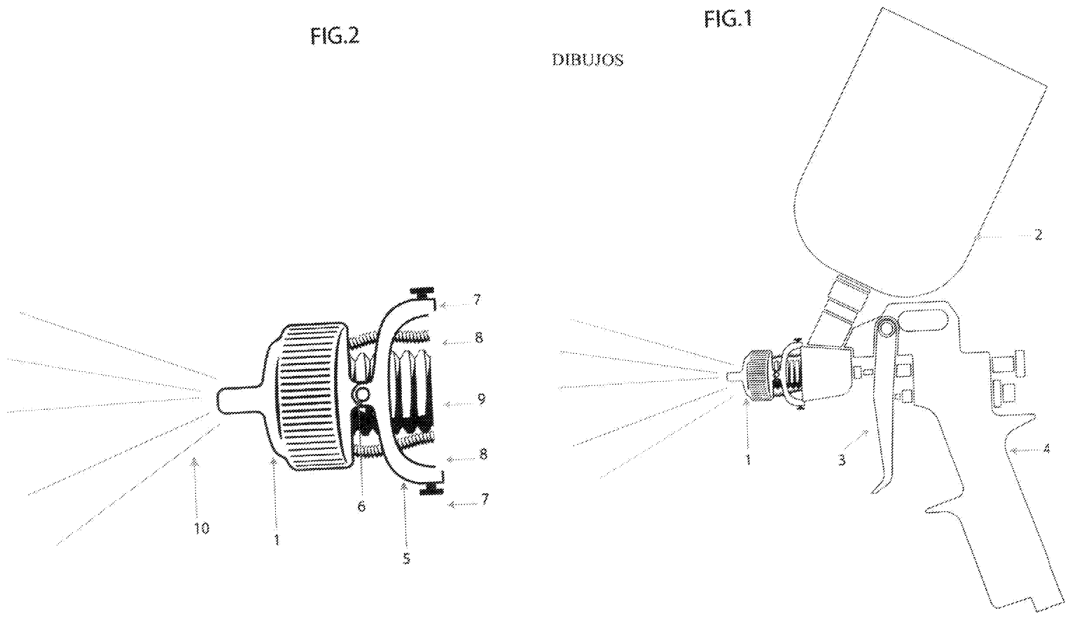

In the current state of art the gun design causes a straight beam and it is difficult to apply to the surfaces of the lateral or rear faces of three-dimensional bodies with corners or edges, which can be of variable dimensions and be situated in limited space areas. The proposed invention is an extendible head of the jet spray liquid gun nozzle formed by a certain number of predefined articulated, combined and stacked clamp modules assembled by the user in each case at the end of which a front-end projection head module is installed that is articulated with the clamp supporting modules in an unlimited number, through which extend a bellows that channels the liquid to be sprayed, two pressurised air supply hoses able to prevent ruptures, all of them with variable length for each case selected by the user that allow the extendible arm to project liquid spray can be bent to be applied with the appropriate angle to the lateral or rear faces of three-dimensional bodies of variable sizes. (FIG. 1 and FIG. 2)

### DISCLOSURE OF THE INVENTION

The invention is an extendible and articulated rotary head of a in a public domain gun nozzle for a pressurised air jet spray formed by a base clamp module (5) to join the gun body in the form of a quadrilateral with curved arch-shaped sides whose centre has a projection with a hole with thread where an screw device (7) joined to the body of the gun by an axis can be placed and a screw-nut device (6) in the perpendicular transverse axial axis to assemble with the next combined and stacked clamp or with the front-end module of the projection nozzle (1), an unlimited number of these intermediate articulated clamp modules can be articulated to reach the front-end projection module (FIG. 2).

The second type of combined articulated module located at the end of the set is the front-end or front nozzle (1) that roots in the preceding external end of the set by means of two rotating screws in the preceding clamp module that holds it (6) with which it is articulated. The front-end module with nozzle is in the form of a hollow truncated cylinder (FIG. 4) joined by means of a flexible bellows (9) that channels the paint cartridge or another liquid to be sprayed (2) with outlets in the rear external face of the front-end for pressurised air connected to the air supply hoses able to prevent ruptures (8) and a central outlet for the paint or any other liquid to be sprayed placed into the needle tip (11) blocked or clogged by a shut-off needle tip (11) that can be extracted from the outlet by pulling a trigger (3) from its back end in order to release the spray jet of pulverized paint or liquid impelled by the pressurised air (10) with the new essential characteristic consisting in that needle is divided or decomposed into two parts, one of them is the tip (11) and the other is the rod (13) joined by a flexible, high-tenacity traction wire made of steel, industrial nylon or equivalent material (12), to allow the head bending in such a way the needle does not break. The front part of the needle is the needle tip located in a guide with a recovery spring (14) to relocate it in a obstructing position when the trigger traction ends and the rear part of the needle is an axis or cylindrical rod located in the body of the gun that retracts (13) and causes backward traction by means of a trigger and because of it is joined to the needle tip by means of the flexible high-tenacity traction wire it allows the needle axis bending when the front-end module with nozzle where its tip is located rotates (FIG. 5), this tip joins from the guide it is located to the rigid axis of the needle located in the cylindrical body of the gun axis by means of the flexible, high-tenacity traction wire, which allows the head can be bent (FIG. 5) to adapt the liquid projection to the rear part of corners and edges of the body that has to be painted or pulverised and to increase the distance between the user and the jet spray for health and safety reasons.

Through the clamp modules extend a bellows that channels the liquid (9) connected with the cartridge or tank (2) for the liquid that has to be sprayed that ends in the cylindrical trunk of the front-end module of the nozzle (FIG. 4) to lead the impregnating liquid and two pressurised air supply hoses able to prevent ruptures (8) that end in the air outlets in the external face of the front-end.

### DESCRIPTION OF THE DRAWINGS

In FIG. 1 a jet spray in a public domain gun is presented in side profile with its projection nozzle (1), the cartridge or tank for the liquid that has to be pulverised (2), the handle (4) and the traction trigger of the obstructive needle (3).

In FIG. 2 the new invented nozzle head is presented in side profile (1) with the supporting clamp (5), the screws in the perpendicular axial axis for connection with the preceding module or with the front module (7 and 6), the bellows that channels the liquid (9), the pressurised air supply hoses able to prevent ruptures (8) and the spray jet (10).

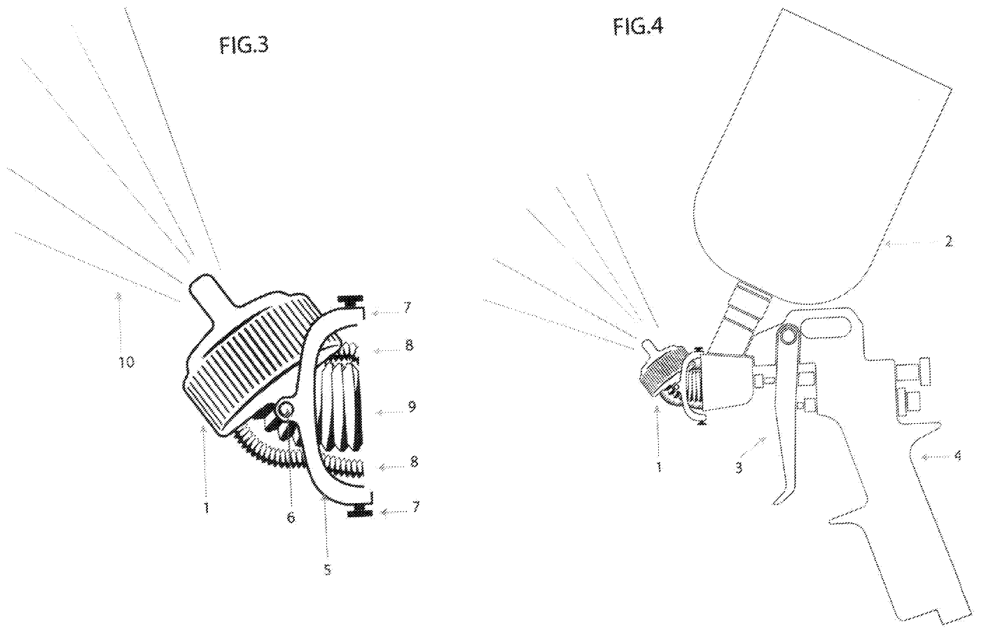

In FIGS. 3 and 4 the projection nozzle head (1) is presented in two swivel positions in plan view from the upper part of the tank (2) with the supporting clamp (5) articulated on two connecting screws, one of them (6) with the nozzle (1) and another two on the body of the gun (7), with two pressurised air supply hoses able to prevent ruptures (8) and the bellows that channels the liquid that has to be sprayed inside (9).

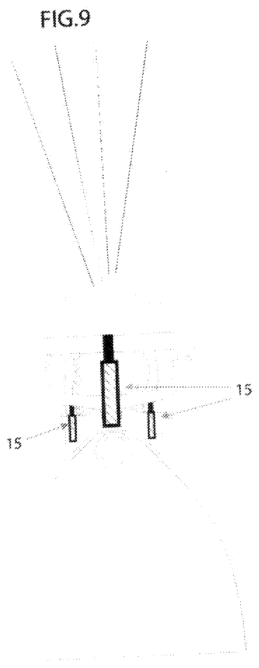

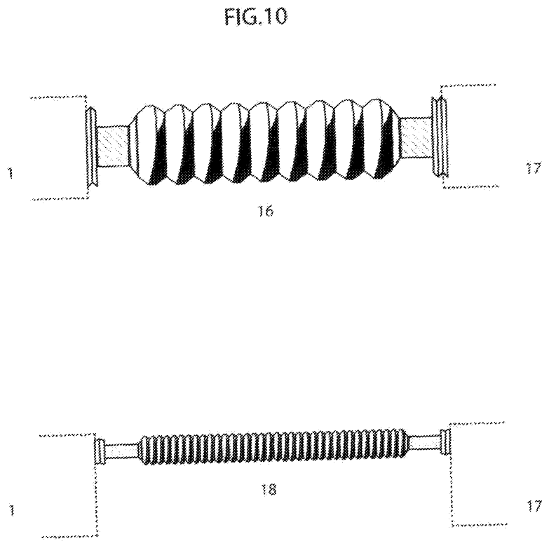

In FIGS. 7 and 8 the needle located in the head decomposed in two parts is presented in plan view in two positions, the needle tip (11) with a recovery spring (14) located in a head guide cylinder with an outlet in the centre of the external face, the high-tenacity traction joining wire (12) and the retractable needle axis or rod (13) that activates by pulling the trigger.

In FIG. 9 the head with the pneumatic or electric pistons that are operated with one hand to cause the head rotation is presented in plan view.

In FIG. 10 in detail the bellows that channels the liquid (16), as submitted assembled in (9) and the pressurised air hose able to prevent ruptures (18) as submitted assembled in (8) that join the base (17) to the nozzle (1) are presented.

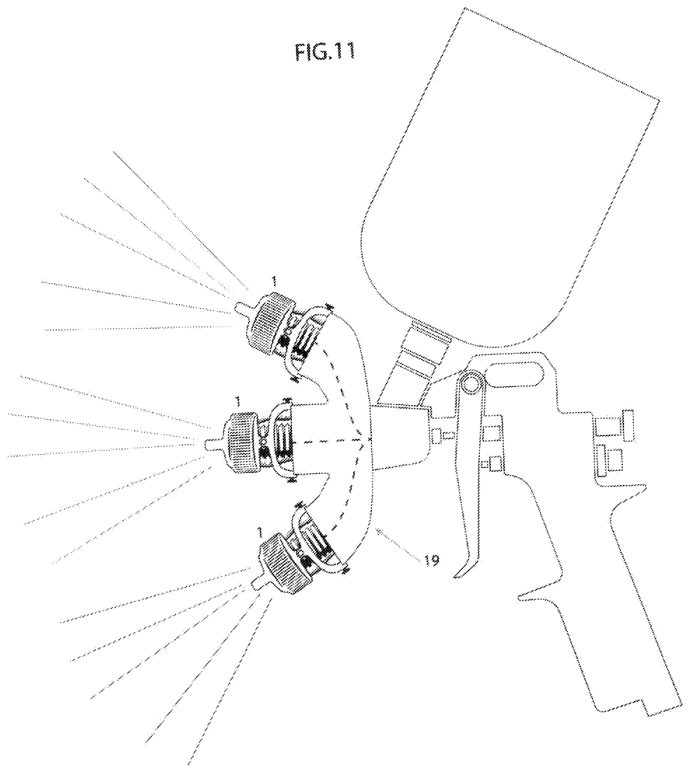

In FIG. 11 a triple head mounted on a tubular structure with three openings is presented (19).

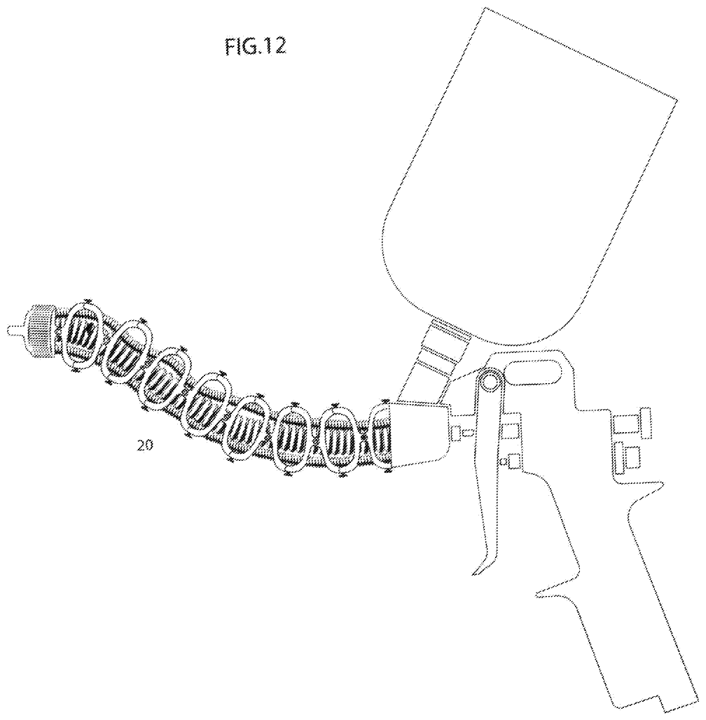

In FIG. 12 a projection head articulated spread neck with multiple articulated clamps and the front end of the head nozzle (20) are presented.

### INSTRUCTIONS AS TO THE BEST WAY OF BRINGING THE INVENTION INTO EFFECT

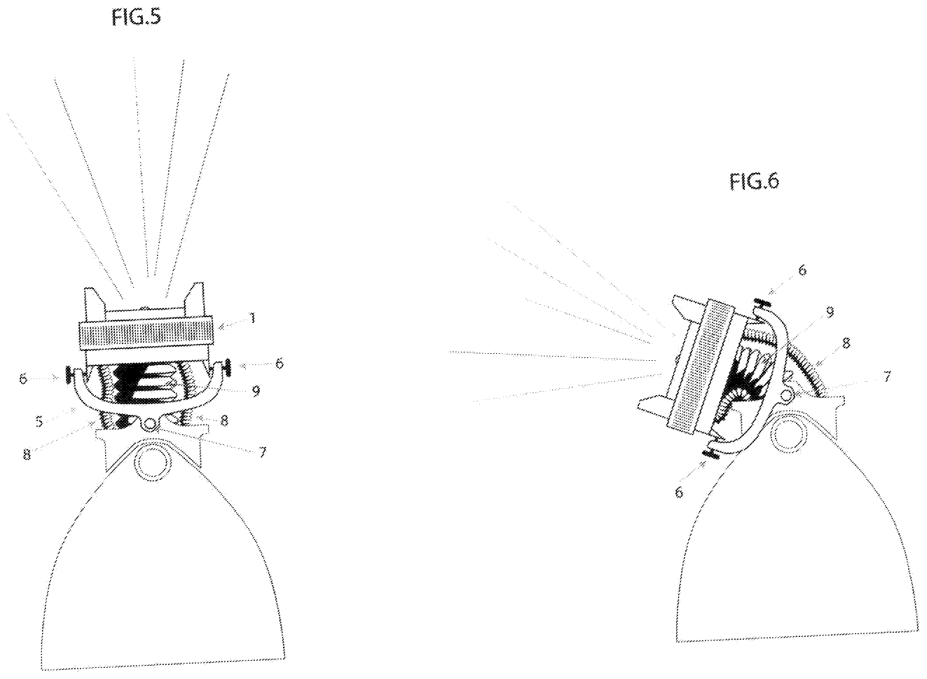

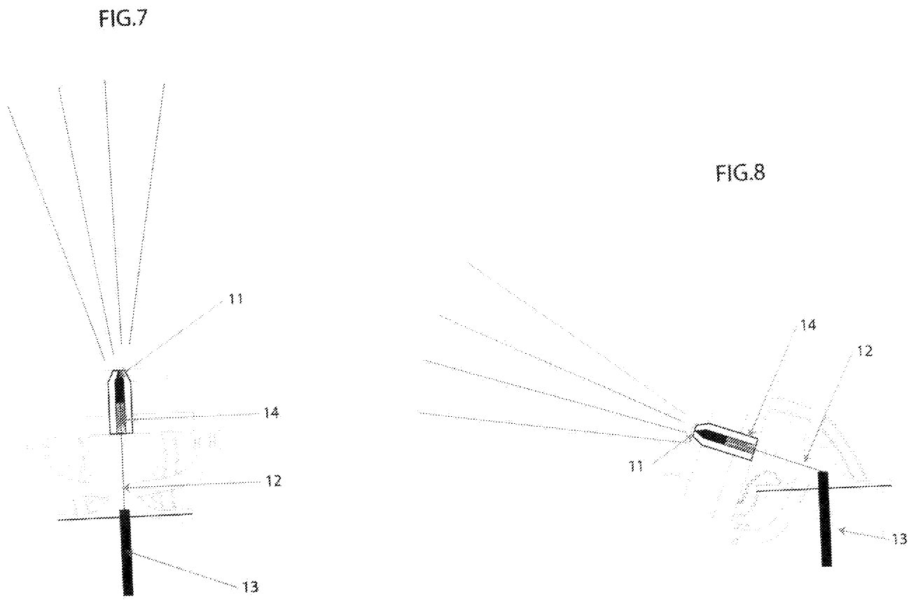

The best way of bringing the invention into effect consists in a set of clamp modules (5), the first of which is installed at the base of union with the body of the gun in the form of a quadrilateral with curved arch-shaped sides whose centre has a projection with a hole with thread where an screw device (7) joined to the body of the gun by an axis can be placed and a screw-nut device (6) in the perpendicular transverse axial axis to assemble with the next combined and stacked clamp or with the front-end module of the projection nozzle (1), every combined and stacked module are articulated with each other, joined at the end of the line to the front-end module of the projection nozzle, so that next modules are sustained and the articulated rotation of every module in left or right direction or up and down is allowed and through which extend a bellows that channels the liquid to be sprayed (9), the hollow air supply hoses able to prevent ruptures (8) and the paint outlet blocking needle (11). The second type of articulated module is the nozzle front-end (FIG. 2) that roots in the preceding external end of the set by means of two rotating screws (7) to the preceding clamp module that holds it (5) with which it is articulated. The front-end module is in the form of a hollow truncated cylinder joined by means of a flexible bellows (9) that channels the paint cartridge or another liquid to be sprayed (2) with outlets in the preceding external face of the front-end for pressurised air connected to the air supply hoses able to prevent ruptures and a central outlet for the paint or any other liquid to be sprayed (FIG. 6) blocked or clogged by a shut-off needle tip (11) that can be extracted from the outlet by pulling a trigger (3) from its back end in order to release the spray jet of pulverized paint or liquid impelled by the pressurised air with the new essential characteristic consisting in that needle is divided or decomposed into two parts (FIG. 6, 11, tip, and 13, rod) joined by a flexible, high-tenacity traction wire made of steel, industrial nylon or equivalent material (12). The front part of the needle is the needle tip located in a guide with a recovery spring (14) to relocate it in a obstructing position when the trigger traction ends and the rear part of the needle is an axis or cylindrical rod (13) located in the body of the gun that retracts and causes backward traction by means of a trigger and because of it is joined to the needle tip by means of the flexible high-tenacity traction wire it allows the needle axis bending when the front-end module where its tip is located rotates (FIG. 7), this tip joins from the guide it is located to the rigid axis of the needle located in the cylindrical body of the gun axis by means of the flexible, high-tenacity traction wire, which allows the head can be bent (FIG. 5) to adapt the liquid projection to the rear part of corners and edges of the body that has to be painted or pulverised.

### WAYS OF COMMERCIAL USE

The proposed invention is susceptible to be commercially used in the sector of spray-painting, enameling and treatment of surfaces.

1. ARTICULATED AND EXTENDIBLE ROTARY HEAD FOR A PRESSURISED AIR JET SPRAY GUN essentially characterised by consisting of the union between two types of rotary modules that are articulated, combined and stacked (FIG. 1 and FIG. 12). so that they can be bent for use on corners or edges to be painted The first one is a supporting hollow clamp module (5) in the form of a quadrilateral with curved arched sides whose centre has a projection with two anchor rotating screws (7) on the body of the gun axis or two other anchor rotating screws (6) on another preceding clamp module and on the perpendicular axial axis in order to join it to next intermediate module to support next modules and to allow the articulated rotation of every module in left or right direction or up and down through which extend a bellows that channels the liquid to be sprayed (9), inside of which extend the hollow air supply hoses able to prevent ruptures (8) and the paint outlet blocking needle (11). The second type of articulated module is the front-end with nozzle (FIG. 2 and FIG. 6) that roots in the preceding external end of the set by means of two rotating screws (6) to the preceding clamp module that holds it with which it is articulated. The front-end module is in the form of a hollow truncated cylinder (FIG. 6) joined by means of a flexible bellows (9) that channels cartridge or tank for the paint or another liquid to be sprayed (2) inside of which is the traction wire and with outlets in the rear external face of the front-end for pressurised air connected to the air supply hoses able to prevent ruptures (8) and a central outlet for the paint or any other liquid to be sprayed (FIG. 6) blocked or clogged by a shut-off needle tip (11) that can be extracted from the outlet by pulling a trigger (3) from its back end in order to release the spray jet of pulverized paint or liquid impelled by the pressurised air (10) with the essential characteristic consisting in that needle is divided or decomposed into two parts, tip (11) and rod (13), joined by a flexible, high-tenacity traction wire made of steel, industrial nylon or equivalent material (12). The front part of the needle is the needle tip (11) located in a guide with a recovery spring (14) to relocate it in a obstructing position when the trigger traction ends and the rear part of the needle is an axis or cylindrical rod (13) located in the body of the gun that retracts and causes backward traction by means of a trigger (3) and because of it is joined to the needle tip by means of the flexible high-tenacity traction wire it allows the needle axis bending when the front-end module where its tip is located rotates (FIG. 8), this tip joins from the guide it is located to the rigid axis of the needle located in the cylindrical body of the gun axis by means of the flexible, high-tenacity traction joining wire (12), which allows the head can be bent to adapt the liquid projection to the rear part of corners and edges of the body that has to be painted or pulverised.

2. ARTICULATED AND EXTENDIBLE ROTARY HEAD FOR A PRESSURISED AIR JET SPRAY GUN according to claim 1, essentially characterized by having two or more front-end modules that are articulated with a clamp module in turn articulated with the end of a tubular piece that has several union arms to the body of the gun (19).

3. ARTICULATED AND EXTENDIBLE ROTARY HEAD FOR A PRESSURISED AIR JET SPRAY GUN according to claim 1, essentially characterized by being fitted with a set of pistons (15) of pneumatic or hydraulic bottle (FIG. 9) in the clamp articulated module that is the base of union with the body of the gun to control the articulated modules rotation and the spray jet direction with the same hand that holds the gun.

4. ARTICULATED AND EXTENDIBLE ROTARY HEAD FOR A PRESSURISED AIR JET SPRAY GUN
